(19) United States
(12) Patent Application Publication
(10) Pub. No.: US 2014/0178292 A1
(43) Pub. Date: Jun. 26, 2014

(54) HYDROGEN-STORAGE-MATERIAL

(71) Applicant: CELLA ENERGY LIMITED, Didcot (GB)

(72) Inventors: Stephen BENNINGTON, Didcot (GB); Arthur LOVELL, Didcot (GB); Tom HEADEN, Didcot (GB); Anna PLOSZAJSKI, Didcot (GB); Joseph COOK, Didcot (GB); Zeynep KURBAN, Didcot (GB)

(73) Assignee: CELLA ENERGY LIMITED, Didcot (GB)

(21) Appl. No.: 14/137,703

(22) Filed: Dec. 20, 2013

(30) Foreign Application Priority Data
Dec. 21, 2012 (GB) 1223264.1

(51) Int. Cl. C01B 3/00

(52) U.S. Cl. CPC C01B 3/0078
USPC 423/658.2; 252/188.25; 264/8

(57) ABSTRACT

A hydrogen-storage-material comprising ammonia borane and poly(ethylene oxide).

The present invention relates to a hydrogen-storage-material, to a method of releasing hydrogen from the hydrogen-storage-material, to a method of manufacturing the hydrogen-storage-material and to the use of poly(ethylene oxide) in a hydrogen-storage-material to reduce foaming and/or swelling of the hydrogen-storage-material when hydrogen is released from the ammonia borane.

The use of hydrogen as a fuel in portable applications holds many advantages due to the high gravimetric energy density of hydrogen and efficient conversion to electrical energy using a fuel cell with zero greenhouse gas emissions at the point of use. The main barrier to the adoption to hydrogen as a fuel is that storage remains difficult, with high pressure gas storage only achieving hydrogen capacity of ˜5 wt % for the fuel system. A potential solution to the storage problem is to use solid state chemical hydrides. In general these materials can contain upwards of 10 wt % hydrogen which is released upon heating of the materials. However for many of these materials the hydrogen release is non-reversible. Therefore, in order that the hydrogen release may be controlled, they have to be portioned so that only part of the hydrogen release occurs at any one time. This may be achieved for example by:
1. Moving the material as pellets or beads in batches into a hot cell for a certain period of time, where the gas is released and “empty” pellets moved to a waste container; or
2. Keeping the portions of the material static but separated by a thermally insulating material. Each portion individually releases its hydrogen using an individual heating element.

One potential hydrogen storage material is ammonia borane (NH₃BH₃) which contains 12.5 wt % of hydrogen that is releasable upon heating to 150° C. A major barrier to the take up of ammonia borane as a solid state hydrogen storage compound is that its melting point coincides with the first release of hydrogen at around 100° C. This causes the ammonia borane to foam, destroying its structural integrity. Thus, heating ammonia borane in its solid state at, for example at temperatures of from about 100 to 250° C. in the absence of a suitable foam suppression reagent or additive, causes the ammonia borane to undergo a dramatic change in volume as it liberates hydrogen. If liquid ammonia borane exists in the material then this generates a waxy foam, it can also cause the material to swell and increase in volume sometimes by as much as 200%.

Furthermore, at lower hydrogen release temperatures, pure ammonia borane exhibits an incubation time before the hydrogen is released. For example, at 85° C. pure ammonia borane may take up to 90 minutes to start releasing significant quantities of hydrogen gas.

Thus, the use of ammonia borane in hydrogen storage materials may be problematic due to one or more of the following issues (1) relatively high reaction temperatures required for hydrogen release, (2) slow rates of hydrogen release (3) swelling and/or (4) foaming.

It is one object of the present invention to overcome or address the problems of prior art hydrogen storage materials or to at least provide a commercially useful alternative thereto. It is an alternative and/or additional object to provide a hydrogen storage material which is cheaper to make and/or more effective than known hydrogen storage materials. It is an alternative and/or additional object to provide hydrogen storage materials which exhibit shorter incubation times at low temperatures (for example at temperatures below 85° C.) before hydrogen is released. It is an alternative and/or additional object to provide hydrogen storage materials in which, upon heating, foaming and/or swelling is reduced.

In the first aspect there is provided a hydrogen-storage-material comprising ammonia borane and poly(ethylene oxide). The hydrogen-storage-material may consist of ammonia borane and poly(ethylene oxide).

The present invention will now be further described. In the following passages different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous.

In a further aspect there is provided a method for releasing hydrogen stored within the hydrogen-storage-material as described herein, the method comprising heating the material to release hydrogen from the ammonia borane.

In a further aspect there is provided a method of manufacturing the hydrogen-storage-material as described herein, the method comprising dissolving ammonia borane and poly(ethylene oxide) in a solvent to form a solution; and solidifying said solution to form the hydrogen-storage-material.

In a further aspect there is provided the use of poly(ethylene oxide) in a hydrogen-storage-material comprising ammonia borane to reduce foaming and/or swelling of the hydrogen-storage-material when hydrogen is released from the ammonia borane.

The inventors have surprisingly found that providing a hydrogen-storage-material comprising ammonia borane and a poly(ethylene oxide), results in a material whose structural integrity can be substantially maintained during and after hydrogen release; and/or foaming is reduced during and/or after hydrogen release; and/or swelling is reduced during and/or after hydrogen release and/or wherein the material's incubation times can be reduced, preferably to zero.

The term “foaming” refers to the mechanisms and/or processes whereby gas present in a hydrogen-storage-material generates bubbles therein as the gas is released. The term “foam” means the frothy material formed on a material as a result of gas bubbles forming inside a liquid medium.

The term “swelling” means the volume change that occurs when gas is trapped within a solid or viscous liquid which causes the material to expand or change dimensions or exceed its initial footprint or boundaries. The extent of expansion or dimension changes are typically determined by both the rate and the quantity of gas introduced to and released from the material.

In one embodiment of the present invention, the hydrogen-storage-material comprises a mixture, preferably an intimate mixture, or homogeneous mixture of ammonia borane and poly(ethylene oxide).

However, preferably, the hydrogen-storage-material is formed from a solidified solution comprising ammonia borane and poly(ethylene oxide) dispersed, more preferably dissolved, or substantially dissolved, therein.

More preferably still, the hydrogen-storage-material is in the form of a solid solution. As used herein the term solid solution includes a solid material which has been formed by dissolving ammonia borane and poly(ethylene oxide) in a solvent, and then removing said solvent to form a solid.

Preferably, the hydrogen-storage-material has a single phase comprising ammonia borane and poly(ethylene oxide). The present inventors have prepared various hydrogen-storage-materials comprising ammonia borane (AB) and poly(ethylene oxide) (PEO) and prepared a AB-PEO phase diagram using differential scanning calorimetry (details of the experiments are provided below). Advantageously, the present inventors have found that for materials comprising, or consisting of, poly(ethylene oxide) up to 70% by weight, and preferably from 25 to 70% by weight, ammonia borane based on the total weight of the material, only a single melting curve is observed indicating that over this range, only a single phase is present. Moreover, advantageously, when such a material is heated to release hydrogen from the ammonia borane, no, or substantially no foaming is observed. Moreover, advantageously, incubation periods at temperatures below the ammonia borane melting point (100° C.) are reduced compared to when only ammonia borane is used.

Preferably, the hydrogen-storage-material comprises 70% or less, or less than 70%, by weight of ammonia borane based on the total weight of the material. The hydrogen-storage-material may comprise 65% or less, 60% or less, or 50% or less, by weight of ammonia borane based on the total weight of the material. The present inventors have found that although the amount of hydrogen present in the material increases as the ammonia borane increases, if it is present in amounts of greater than 70% by weight based on the total weight of the material then foaming is observed. Advantageously for material comprising 70% or less by weight of ammonia borane based on the total weight of the material reduced, or no, foaming is observed.

Preferably, the hydrogen-storage-material comprises 20% or more by weight of ammonia borane based on the total weight of the material. More preferably, the hydrogen-storage-material comprises 25% or more, 30% or more, 35% or more, 40% or more, 50% or more by weight of ammonia borane based on the total weight of the material. Preferably the weight percentage of ammonia borane is kept above 20% by weight of the total weight of the material so that the hydrogen weight percentage in the material is reasonably high. It is advantageous for the weight of hydrogen to be as high as possible in order to ensure that the material is as efficient a hydrogen storage material as possible per unit weight of material. However, this requirement needs to be balanced with the advantages associated with the effect of the poly(ethylene oxide) on the properties of the ammonia borane upon hydrogen release.

Most preferably, the material comprises from 25% to 70%, or from 30% to 65%, or from 35% to 60%, by weight of ammonia borane based on the total weight of the material. These ranges are particularly preferred when the material has a single solid phase.

Preferably, the hydrogen-storage-material comprises 30% or more by weight of poly(ethylene oxide) based on the total weight of the material. More preferably the hydrogen-storage-material comprises 35% or more, or 40% or more by weight of poly(ethylene oxide) based on the total weight of the material.

Preferably, the hydrogen-storage-material has a weight ratio of ammonia borane to poly(ethylene oxide) in the range of approximately 70:30 to 30:70, or from 65:35 to 40:60, or from 60:40 to 40:60. Preferably, the hydrogen-storage-material has a weight ratio of ammonia borane to poly(ethylene oxide) in the range of approximately 70:30 to 50:50, or 65:35 to 55:45.

As used herein the term poly(ethylene oxide) describes a polymer having the repeat unit of:

—CH₂—CH₂—O—

and a weight average molecular weight of greater than 20,000 g/mol. Preferably, the poly(ethylene oxide) has a weight average molecular weight of greater than or equal to 1 MDa, preferably greater than or equal 1.5 MDa and more preferably greater than or equal to 2 MDa. It is preferable to use poly(ethylene oxide) having weight average molecular weight of greater or equal to 1 MDa, preferably greater than or equal to 1.5 MDa or greater than or equal to 2 MDa as above these weight average molecular weights the present inventors has found that the poly(ethylene oxide) provides improved structural rigidity to the material compared to when lower molecular weights poly(ethylene oxide) are used, particularly at higher temperatures. The present inventors have also found that low molecular weight poly(ethylene oxide)s are less viscous upon melting compared to higher molecular weight poly(ethylene oxide)s and therefore increased foaming is observed upon heating the material comprising the low molecular weight poly(ethylene oxide)s.

Examples of suitable weight average molecular weights for poly(ethylene oxide)s include approximately 3 MDa, 4 MDa, 5 MDa, 6 MDa, 7 MDa. Preferably, the poly(ethylene oxide) has a weight average molecular weight in the range of less than or equal to 9 MDa, preferably less than or equal to 8 MDa. Poly(ethylene oxide) suitable for use in the present invention is available commercially. The higher the molecular weight of the poly(ethylene oxide) the more viscous the material. It may be advantageous to use higher molecular weight poly(ethylene oxide) in order to provide a material having increased mechanical strength. However, in embodiments of the invention which require dissolution of the polymer into a solvent to form the material, it may be necessary to only use small quantities of the high molecular weight polymer so that it can be dissolved into a solvent.

A mixture of one or more poly(ethylene oxide)s having different molecular weights may be used in the present invention.

The poly(ethylene oxide) may be linear or branched. The poly(ethylene oxide) may be functionalised on one or both of the carbon atoms in the —CH₂—CH₂—O— repeat unit. For example, it may be functionalised with a halogen, or a C₁ to C₆ alkyl or any suitable substituent.

The poly(ethylene oxide) may form part of a copolymer.

Preferably the poly(ethylene oxide) polymer comprises only the repeat unit of: —CH₂—CH₂—O—. Preferably the poly(ethylene oxide) has the formula:

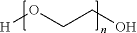

wherein n is chosen to provide the required polymer visocity/chain length.

The term “weight average molecular weight” used herein is calculated as follows:

$${M}_{w} = \frac{{\sum }_{i} {N}_{i} {M}_{i}^{2}}{{\sum }_{i} {N}_{i} {M}_{i}}$$

where Nᵢ is the number of molecules of molecular weight Mᵢ.

Advantageously, the hydrogen-storage-material as described herein may be in the form of a freeze dried material.

The hydrogen-storage-material as described herein may be in powder or particulate form. Alternatively, the hydrogen-storage-material may be made into a solid of any desired size or shape that the application requires.

The hydrogen-storage-material may be formed into a variety of shapes including, but not limited to e.g. wafers, discs, tapes, pellets, monoliths, buttons, or other structured solid forms which preferably do not crumble or lose their initial shape. The hydrogen-storage-material as described herein, may be formed into a solid pre-defined shape by pressing, pelletising, casting, tableting, extrusion, or by two or more thereof.

The incubation time of the material until hydrogen release may be measured by techniques such as thermogravitic analysis combined with mass spectrometry, where the material is heated to a defined temperature such as 85° C. and the mass loss and hydrogen release is measured as a function of time. Foaming and swelling may be measured by observing a material as it is being heated. One suitable method includes adding the material to a test tube suspended in an oil bath maintained at a temperature such as 120° C. and measuring the foam height (if any) and pellet volume change before and after heating for long enough for hydrogen release to occur—usually 5 minutes.

Preferably the volume of the material, comparing it before hydrogen release to after hydrogen release therefrom, has changed in the range of from about 0% to about 200% by volume, more preferably, it changes in the range of from about 0% to about 100% by volume, or from about 0% to 50% or about 0% to about 10% by volume. Preferably, the volume of the material, comparing it before hydrogen release to after hydrogen release therefrom changes by less than 50% by volume, less than 20% by volume, more preferably by less than 10% by volume based on the total volume of the material.

The hydrogen-storage-material as described herein is suitable for storing and releasing hydrogen upon demand. Thus, the hydrogen-storage-material may be used as a hydrogen source, or hydrogen fuel source.

In one aspect of the present invention there is provided a method for releasing hydrogen stored within the hydrogen-storage-material as described herein, the method comprising heating the material to release hydrogen from the ammonia borane. Typically, heating the material to from about 60° C. to 250° C. will release at least some of the hydrogen from ammonia borane.

In one embodiment the material may be made by grinding or mixing the solid poly(ethylene oxide) and the ammonia borane together to form an intimate mixture.

In one aspect of the present invention there is provided a method of manufacturing of the hydrogen-storage-material as described herein, the method comprising mixing a powder of ammonia borane a with a powder of poly(ethylene oxide). Preferably the powders are fine and dry prior to mixing. Preferably the powders are mixed to form a substantially homogenous mixture.

In one aspect of the present invention there is provided a method of manufacturing the hydrogen-storage-material as described herein, the method comprising dissolving ammonia borane and poly(ethylene oxide) in a solvent to form a solution; and solidifying said solution to form the hydrogen-storage-material

Any suitable solvent may be used to dissolve the ammonia borane and poly(ethylene oxide) to form a solution. Examples of suitable solvents include, for example, water, acetonitrile, dimethylfomamide or mixtures thereof.

The solid hydrogen-storage-material may be formed from a solution comprising ammonia borane and the poly(ethylene oxide) by using a technique that dries it rapidly such as: single phase electrospinning, electrospraying, vacuum drying, or by freeze drying.

Preferably, the method comprises dissolving and/or dispersing poly(ethylene) oxide in a solvent to form a solution, then dissolving and/or dispersing ammonia borane in the solution. The solution comprising ammonia borane and poly(ethylene) oxide is then treated to from a solid solution hydrogen-storage-material, and/or a single phase material. Preferably the poly(ethylene) oxide and/or the ammonia borane are dissolved in the solvent.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

These and other aspects of the invention will now be described with reference to the accompanying Figures, in which:

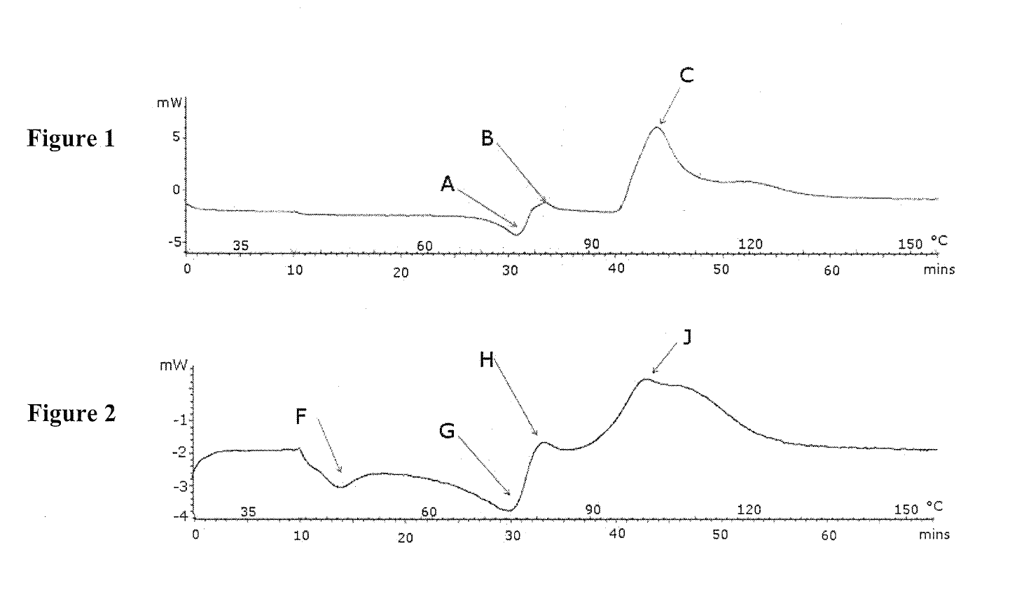

FIG. 1: shows a typical DSC curve for high wt % AB (ammonia borane) samples for the fast (2° C./min) ramp heat. The figures shows the curve for sample FD120926-01 (60 wt % AB) for a fast ramp heat produced using the Mettler Toledo STARe software. The “Peak” tool is shown here calculating the strong exothermic peak on the right.

FIG. 2: shows a typical DSC curve for low wt % AB samples, both for the fast (2° C./min) ramp heat. The figure shows the curve for sample FD121002-04 (20 wt % AB) for a fast ramp heat produced using STARe software. Note the additional endothermic trough at approximately 42° C. present in this sample.

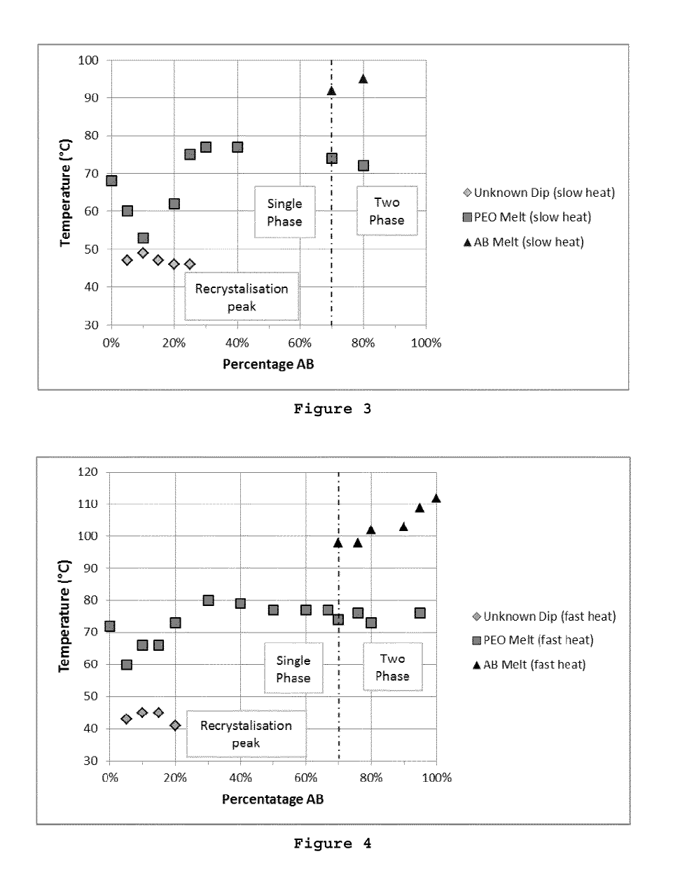

FIG. 3: DSC results for a heating rate of 1° C./min

FIG. 4: DSC results for a heating rate of 2° C./min

The following non-limiting examples further illustrate the present invention.

### EXAMPLE 1

Production of 66 wt % Ammonia Borane (AB) 33 wt % Polyethylene Oxide (PEO) pellets by freeze drying followed by extrusion to form pellets:

A 3 wt % solution of PEO (molecular weight 2 MDa, Sigma Aldrich) is made in deionised water and left to stir for at least 24 hours until completely dissolved to a viscous solution. Ammonia borane powder of double the mass of PEO added is then added along with an amount of polyethylene oxide (molecular weight 200 Da) to give a solids content of 0.5%. The solution is stirred for 2 hours until dissolved—the solution made is normally cloudy but no particles of AB can be seen. After AB dissolution the solution is poured into an evaporating basin of appropriate diameter such that the thickness of the solution is less than 2 cm. The solution is then left in a freezer below −10° C. until completely frozen (usually at least 4 hours). Water is then removed from the solution by freeze drying under vacuum with condenser temperature at −55° C. for 2 days. The resulting composite is collected from the evaporating basin and extruded through a twin screw extruder working at 70° C.—the time in the extruder is kept below 2 minutes, a chipper is used to form the extrudate into cylindrical pellets of aspect ratio approximately 1:1.

The foam/swelling tests were done by heating the resulting pellets to 120° C. by immersion of a small test tube containing the pellets in a hot oil bath. In this case no foaming was seen but the dimensions of the pellets change showing an average reduction in volume of 5%. The pellets remain solid during the experiment and can be removed from the test tube in one piece once cooled. The samples were tested for hydrogen release by combined thermogravimetric analysis and mass spectrometry. Peak hydrogen release is observed at 4.6 minutes, compared with neat Ammonia Borane in which peak release is observed at 6.7 minutes.

### EXAMPLE 2

Production of 66 wt % Ammonia Borane (AB) 33 wt % Polyethylene Oxide (PEO) composite by vacuum drying from Acetonitrile.

A 250 ml Schlenk tube is filled with 1 g of PEO powder (molecular weight 2 MDa) and 30 g of acetonitrile and the mixture is stirred for at least 24 hrs at 40° C. until a viscous solution is formed. To this solution 2 g of Ammonia Borane (AB) powder is added at room temperature and stirred for at least 2 hours until no AB powder is visible. The Schlenk tube is sealed and slowly exposed to vacuum (approximately 10⁻³ mbar) to remove the acetonitrile solvent which is collected before the vacuum pump using a liquid nitrogen cooled cold trap. Once all the liquid has been removed the composite solid is kept under vacuum for at least 4 hours. The resulting solid is then milled to a power using a knife mill. The resulting powder is extruded to pellets as described in example 1.

The samples were tested for hydrogen release by combined thermogravimetric analysis and mass spectrometry. Peak hydrogen release is observed at 4.6 minutes, compared with neat Ammonia Borane in which peak release is observed at 6.7 minutes.

### EXAMPLE 3

Production of a Ammonia Borane Polyethylene Oxide (PEO) composite by powder mixing and pressing.

Ammonia Borane powder is mixed with Polyethylene Oxide (8 MDa) by shaking for 20 seconds in a sealed container. The resulting mixture is hand ground in an agate pestle and mortar for 3 minutes. Portions of this mixture are then pressed into 5 mm diameter pellets using a pressure above 1 MPa—this results in a non-friable pellet being formed. A range of samples were made with concentrations between 10 wt. % AB to 90 wt. % AB.

Heating of a pellet in a test tube in an oil bath at 120° C. leads to visible gas release within 2 minutes and a volume expansion after 5 minutes below 15%.

The foam tests showed results largely similar to those seen with the freeze dried materials in that little foaming was seen below concentrations of 70% wt. % AB. However, the results were more inconsistent than the freeze dried material for some of the lower concentration materials due to inconsistencies in complete mixing.

### EXAMPLE 4

Electrospinning of and Ammonia Borane (AB)—Polyethylene Oxide (PEO) composite from Acetonitrile

The solution for electrospinning is made by first dissolving PEO (molecular weight 2 MDa) in Acetonitrile (ACN) at 3 wt % by leaving to stir at moderate temperature (−40° C.) for 2 days. The AB at double the mass of PEO added is added 30 minutes prior to use. This gives enough time for the AB to dissolve, but also minimises gas release. The electrospinning is performed through 10 nozzles simultaneously with a flow rate of 0.5 ml/hr per nozzle. The tip to collector distance was 30 cm and the electric field between the injector and the collector plate varied between 12-15 kV in order to produce spinning with a stable Taylor cone.

Thermo-gravimetric and foam tests show that these materials have similar properties to the freeze dried materials.

### EXAMPLE 5

Solutions of PEO (2 MDa) were made by mixing appropriate masses of PEO and deionised water in a glass bottle and leaving to stir for at least 24 hours. Ammonia borane(AB) powder of the appropriate mass to give the desired AB:PEO ratio was then added and the solution stirred for ˜2 hours until dissolved. AB from Minal Intermediates was used for all samples. After AB dissolution the solution was poured into an evaporating basin of appropriate diameter such that the thickness of the solution was less than 2 cm. The solution was then left in a freezer until completely frozen (usually at least 4 hours). Water was then removed from the solution by freeze drying with condenser temperature at −55° C. for 2 days. If undried regions of the sample remained, freeze drying was continued for an extra day or until dried.

The following samples were prepared:

TABLE 1
AB-PEO samples analysed to produce the initial coarse phase diagram

| | | AB |
|---|---|---|
| Name | AB type | wt % |
| PEO 2M CSC | N/A | 0 |
| FD120809-01 | Minal (second | 10 |
| | batch) | |
| FD120820-01 | Minal (second | 25 |
| | batch) | |
| FD120903-01 | Minal (second | 50 |
| | batch) | |
| FD120713-01 | Minal (first | 66.67 |
| | batch) | |
| FD120829-01 | Minal (second | 75 |
| | batch) | |
| FD120810-01 | Minal (second | 90 |
| | batch) | |
| Minal AB | Minal (second | 100 |
| CSC | batch) | |

All composite samples were made using a 2M PEO solution and were freeze dried. All samples were subjected to three separate DSC runs, apart from the 100% AB sample which only had two runs. The value plotted in the phase diagram was the average temperature of the phase change for runs per sample.

Further materials were prepared and analysed having the compositions outlined in Table 2:

TABLE 2
AB-PEO samples produced for DSC analysis

| | | AB |
|---|---|---|
| Name | AB type | wt % |
| FD121002-01 | Minal (second | 5 |
| | batch) | |
| FD121002-02 | Minal (second | 10 |
| | batch) | |
| FD121002-03 | Minal (second | 15 |
| | batch) | |
| FD121002-04 | Minal (second | 20 |
| | batch) | |
| FD121009-01 | Minal (second | 30 |
| | batch) | |
| FD121002-05 | Minal (second | 40 |
| | batch) | |
| FD121002-06 | Minal (second | 95 |
| | batch) | |

Differential Scanning Calorimetry

Initially, three TGA-DSC-MS runs were conducted on each sample. A ramp heat of 2° C./min from 35° C. to 200° C. was ued. The temperatures of the thermodynamic events were calculated from peaks in the DSC curves using the METTLER STARe Software. The repeat experiment was carried out on a higher resolution. This machine is considered to have a higher precision than the TGA-DSC-MS machine used for the previous runs and the slower rate of 1° C./min gives a higher resolution.

FIG. 1 shows a typical DSC curve for high wt % AB samples, and FIG. 2 for low wt % AB samples, both for the fast (2° C./min) ramp heat.

Positive second differential peaks (“troughs”) represent endothermic events, and negative second differential peaks (“peaks”) represent exothermic events. The temperature values of the peaks were calculated using the software (shown on the right hand side of FIG. 1) and the normalised peak value in W/g was also recorded.

The present inventors have found that:
Decreasing the AB (ammonia borane) content decreases the height of the hydrogen release peak, since the amount of hydrogen released depends on the mass of AB present
Increasing the PEO (poly(ethylene oxide)) content decreases the onset temperature of hydrogen release
Increasing the AB content increases the melting temperature of the PEO-rich phase

Taking out the hydrogen release peaks which are all exotherms and just plotting the endotherms it is possible to get a clearer view of the phase diagram. FIGS. 3 and 4 compare the endotherms in both fast and slow ramp heat experiments.
The AB melting curve is only seen distinctly at 70 wt % AB and above. Below this the AB does not appear to melt before the hydrogen is released. This would explain why foaming is not observed at compositions below 70 wt % AB.
Below 70% AB the melting endotherms that can be identified as the high AB phase does not exist, indicating that the ammonia borane and poly(ethylene oxide) are miscible and make a solid solution.
Between 5% and 25% an extra endotherm appears just below 40° C., This changes dramatically with the heating rate and is likely to be to polymer recyrstalisation.

1. A hydrogen-storage-material comprising ammonia borane and poly(ethylene oxide), wherein the poly ethylene oxide) has a weight average molecular weight of greater than or equal to 1 MDa and of less than or equal to 9 MDa.

2. The hydrogen-storage-material of claim 1 formed from a solidified solution comprising ammonia borane and poly(ethylene oxide) dissolved therein.

3. The hydrogen-storage-material of claim 1 in the form of a solid solution.

4. The hydrogen-storage-material of claim 1 comprising 70% or less by weight of ammonia borane based on the total weight of the material.

5. The hydrogen-storage-material of claim 1 comprising 20% or more by weight of ammonia borane based on the total weight of the material.

6. The hydrogen-storage-material of claim 1 wherein the poly(ethylene oxide) has a weight average molecular weight of greater than or equal to 2 MDa.

7. The hydrogen-storage-material of claim 1 wherein the poly(ethylene oxide) has a weight average molecular weight less than or equal to 8 MDa.

8. The hydrogen-storage-material of claim 1 comprising at least 30% by weight of poly(ethylene oxide) based on the total weight of the material.

9. The hydrogen-storage-material of claim 1 in the form of a freeze dried material.

10. The hydrogen-storage-material of claim 1 in particulate form.

11. The hydrogen-storage-material of claim 1 in the form a solid of any desired shape or size.

12. A method for releasing hydrogen stored within the hydrogen-storage-material as defined in claim 1, the method comprising heating the material to release hydrogen from the ammonia borane.

13. A method of manufacturing of the hydrogen-storage-material as defined in claim 1, the method comprising mixing a powder of ammonia borane with a powder of poly(ethylene oxide).

14. A method of manufacturing the hydrogen-storage-material as defined in claim 1, the method comprising dissolving ammonia borane and poly(ethylene oxide) in a solvent to form a solution; and solidifying said solution to form the hydrogen-storage-material.

15. The method according to claim 14 wherein the hydrogen-storage-material is formed from a solution comprising ammonia borane and the poly(ethylene oxide) by single phase electrospinning, coaxial electrospinning, electrospraying, freeze drying or vacuum drying.

16. Use of poly(ethylene oxide) in a hydrogen-storage-material comprising ammonia borane to reduce foaming and/or swelling of the hydrogen-storage-material when hydrogen is released from the ammonia borane.
